(19) United States
(12) Patent Application Publication
(10) Pub. No.: US 2026/0216978 A1
(43) Pub. Date: Jul. 30, 2026

(54) LENS MANUFACTURING METHOD AND LENS

(71) Applicant: Tamron Co., Ltd., Saitama (JP)

(72) Inventors: Akitoshi YOSHIMURA, Saitama (JP); Takahiro MIZUGUCHI, Saitama (JP); Koei OSEKI, Saitama (JP)

(73) Assignee: Tamron Co., Ltd., Saitama (JP)

(21) Appl. No.: 19/381,762

(22) Filed: Nov. 6, 2025

(30) Foreign Application Priority Data
Jan. 28, 2025 (JP) 2025-012390

(51) Int. Cl. B29D 11/00; G02B 3/00

(52) U.S. Cl. CPC B29D 11/00442; B29D 11/00528; G02B 3/00

(57) ABSTRACT

Provided is a method of manufacturing a lens including a lens surface and a flange expanding radially from a circumference of the lens surface, the method including: filling a gap between a lower mold and an upper mold with a resin material that is energy-beam curable, the lower mold including a concave portion and an annular recess around the concave portion; and curing the resin material with which the gap is filled while irradiating the resin material with an energy beam, in which the annular recess includes an inner circumferential wall portion corresponding to an outer circumferential wall portion of the flange, and the filling includes filling the annular recess with the resin material with the lower mold and the upper mold spaced at the annular recess.

### CROSS-REFERENCE TO RELATED APPLICATIONS

This application is based on and claims the benefit of priority from Japanese Patent Application No. 2025-012390, filed on January 28, 2025, the entire contents of which are incorporated herein by reference.

### BACKGROUND OF THE INVENTION

### Technical Field

The present invention relates to a lens manufacturing method and a lens.

### Related Art

In recent years, devices related to cross reality (XR) have been developed actively. Such devices require reducing in weight, size, and thickness and are additionally required to provide a picture causing no feeling of strangeness for a high sense of immersion. That is, a thin and lightweight device having higher magnification, such as a device that is not highly bulky and enlarges a picture close to the angle of view of a person, is required.

Desirably, such a device has a pancake lens configuration for an eyepiece optical system in which an optical path is folded with polarization as described in JP 2024-4491 A.

Regarding a head-mounted display (hereinafter, referred to as an HMD) having such a pancake lens configuration, for a further improvement in performance, reducing the birefringence of a lens used therein is most effective. This is because such an optical system has a particular configuration in which a beam of light passes through the same lens three times and thus the contribution rate of birefringence is made triple.

Lenses for a pancake lens configuration are mass-produced by injection molding high in productivity. However, according to injection molding, the birefringence of a pancake lens that is thin in thickness and is large in aperture is difficult to improve completely in principle. This is because a gate for injecting resin into a metal mold requires providing as long as injection molding is performed and a certain amount of unavoidable molding distortion occurs in a part of the gate. As a result, unavoidable rotationally asymmetric birefringence occurs around the optical axis.

A cast polymerization method known as another lens manufacturing method enables a solution to the above-described disadvantage of injection molding because no asymmetric molding distortion occurs around the optical axis. As the cast polymerization method, using a tape molding method as in JP 2008-62412 A or a similar method, molding is performed against molding distortion and in consideration of productivity. In such a process, two glass molds made identical in diameter are disposed facing each other and away from each other for a desired thickness. A tape is attached to the radially outer portion of the glass molds and then an energy-beam curable resin, such as a UV curable resin, is injected into the space inside the tape. After sealing, the resin is cured by UV irradiation. Then, the tape is removed and a molded lens is demolded from the glass molds.

In order to enable a lens to be attached to a housing accurately, providing the outer circumferential portion of the optical effective face of the lens with a face for positioning in the direction of the optical axis and a constituent for optically centering that are called “flange” is effective. However, for molding with such glass molds as in JP 2008-62412 A, the glass molds are required to be shaped for forming a flange. Thus, more time and costs are required, leading to a deterioration in productivity.

Considering productivity in cast molding, use of an energy-beam curable resin, such as an ultraviolet (UV) curable resin, is desirable. However, such energy-beam curable resins are significantly lower in viscosity than injection molding resins. Thus, for example, in a case where a mold having a structure in which an optical functional part and a reference face are segmented as in JP 2010-12694 A is used, an energy-beam curable resin easily enters the segment boundary of the mold and then bubbles are generated to cause molding distortion or the resin stays in the mold at the time of demolding to cause contamination in the following shots, leading to a deterioration in productivity. According to the conventional cast polymerization method, secondary processing (so-called centering) is required in order to form a radially outer portion to a lens as a positioning face.

As represented by such a pancake lens configuration, in recent years, reducing in thickness and increasing in aperture have progressed for lenses. Thus, the thickness tends to decrease dramatically relative to the size of the outer diameter. The progress of reducing in thickness causes a lens to have an extremely thin outer circumferential portion. Thus, it is difficult to make the outer circumferential portion have a sufficient-width end face.

As disclosed in JP 2013-202810 A, as a final conclusion, a flange fails to be formed by any method different from injection molding. According to JP 2013-202810 A, as a configuration, an optical surface is compression-molded and then a flange is formed to the outer circumferential portion of the resultant molded product by injection molding.

As in JP 2013-202810 A, in a case where different molding methods are employed for an optical surface and a flange, two types of resins different in the coefficient of linear expansion are used. Thus, as a disadvantage, distortion or detachment may occur due to extremely high or low temperature.

Therefore, from the viewpoint of manufacturing a lens integrated with a flange accurately with high productivity, there is room for study.

Thus, an object of an aspect of the present invention is to achieve a lens manufacturing method enabling a lens integrated with a flange to be manufactured accurately with high productivity and the lens.

### SUMMARY OF THE INVENTION

In order to solve the above disadvantages, according to an aspect of the present invention, provided is a lens manufacturing method including: filling a gap between a lower mold and an upper mold with a resin material that is energy-beam curable, the lower mold including a concave portion and an annular recess around the concave portion on an upper face of the lower mold, the upper mold being disposed with the gap between the concave portion and the upper mold; and curing the resin material with which the gap is filled, while irradiating the resin material with an energy beam through the lower mold or the upper mold, to mold a lens as a cured object of the resin material, the lens including a lens surface and a flange expanding radially from a circumference of the lens surface, in which the filling includes filling the gap with the resin material until a liquid surface of the resin material reaches an inner circumferential wall portion of the annular recess open upward, the inner circumferential wall portion corresponding to an outer circumferential wall portion of the flange.

In order to solve the above disadvantages, according to an aspect of the present invention, provided is a lens including: a lens surface formed of resin; and a flange formed of the resin, the flange expanding radially from a circumference of the lens surface, the flange being integrated with the lens surface, the flange including a flat portion expanding radially from the circumference of the lens surface, in which the flat portion includes a protruding edge that protrudes in a direction of an optical axis and is formed of the resin or a processed mark due to removal processing to the protruding edge.

According to an aspect of the present invention, a lens integrated with a flange can be manufactured accurately with high productivity.

### BRIEF DESCRIPTION OF THE DRAWINGS

FIG. 1 is a sectional view of a lens manufactured by a lens manufacturing method according to an embodiment of the present invention;

FIG. 2 illustrates a processing flow of the lens manufacturing method according to the embodiment of the present invention;

FIG. 3 is a schematic explanatory view for the lens manufacturing method according to the embodiment of the present invention;

FIG. 4 is a partial enlarged sectional view of a lower mold used in the lens manufacturing method according to the embodiment of the present invention;

FIG. 5 is an enlarged sectional view in which a part of FIG. 4 is further enlarged;

FIG. 6 is a schematic explanatory view for the lens manufacturing method according to the embodiment of the present invention;

FIG. 7 is a partial enlarged sectional view illustrating the state of a resin material filled in the lens manufacturing method according to the embodiment of the present invention;

FIG. 8 is a sectional view illustrating an exemplary unit including lenses manufactured by the lens manufacturing method according to the embodiment of the present invention;

FIG. 9 is a schematic explanatory view for a certain step in a lens manufacturing method according to another embodiment of the present invention;

FIG. 10 is a sectional view of a lens manufactured by the lens manufacturing method according to the another embodiment of the present invention; and

FIG. 11 is a schematic explanatory view for a lens manufacturing method according to another embodiment of the present invention.

### DESCRIPTION OF THE EMBODIMENTS

A lens manufacturing method of an embodiment of the present invention will be described below.

### Lens Manufactured by Lens Manufacturing Method

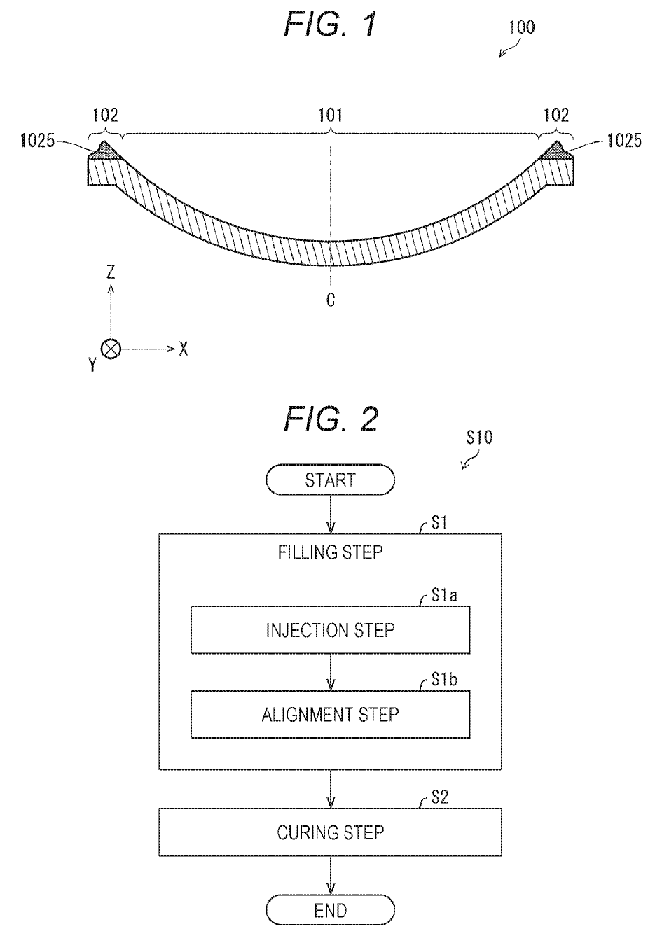

A lens manufactured in the present embodiment will be described with FIG. 1. FIG. 1 is a sectional view illustrating a state where a lens manufactured in the present embodiment is cut along its optical axis. Note that, in the drawing, an XYZ three dimensional coordinate system is illustrated, in which a Z axis is defined as being identical to the optical axis C of a lens 100 and an XY plane is defined as being along the radial direction of the lens 100. The same applies to the following drawings.

The manufactured lens 100 includes a lens surface 101 and a flange 102 expanding radially from the circumference of the lens surface 101. The lens surface 101 and the flange 102 are integrated together.

The lens surface 101 corresponds to an optical effective area. The lens surface 101 includes a convex face on one side and a concave face on the other side. In other words, the lens 100 is a meniscus lens.

The flange 102 includes a flat portion 1021 expanding radially from the circumference of the lens surface 101 and an outer circumferential wall portion 1022.

The flat portion 1021 is provided with a protruding edge 1025 that is formed of resin and protrudes in an optical-axis direction (direction parallel to the optical axis C). The flat portion 1021 has a face expanding orthogonally to the optical axis. Thus, the flat portion 1021 serves as a positioning part for optically centering the lens surface 101.

The outer circumferential wall portion 1022 has a face that prescribes the outer diameter of the lens 100 and extends axially. The outer circumferential wall portion 1022 can be regarded as the outer circumferential face of the lens 100. The outer circumferential wall portion 1022 serves as a positioning part for optically centering the lens surface 101.

The lens 100 is an integrally molded object formed of resin. Such resin will be described later.

As an exemplary achieved lens, the lens 100 has an outer diameter of 10 to 130 mm. In addition, the lens surface 101 has a thickness of 0.5 to 15 mm and the flange 102 has a thickness of 0.5 to 15 mm.

The lens 100 corresponds to a lens having a small birefringence preferably applicable to the above-described pancake lens configuration. Note that the lens 100 is not limited to application to the pancake lens configuration.

### Lens Manufacturing Method

In the present embodiment, a lens manufacturing method for manufacturing the above-described lens 100 will be described.

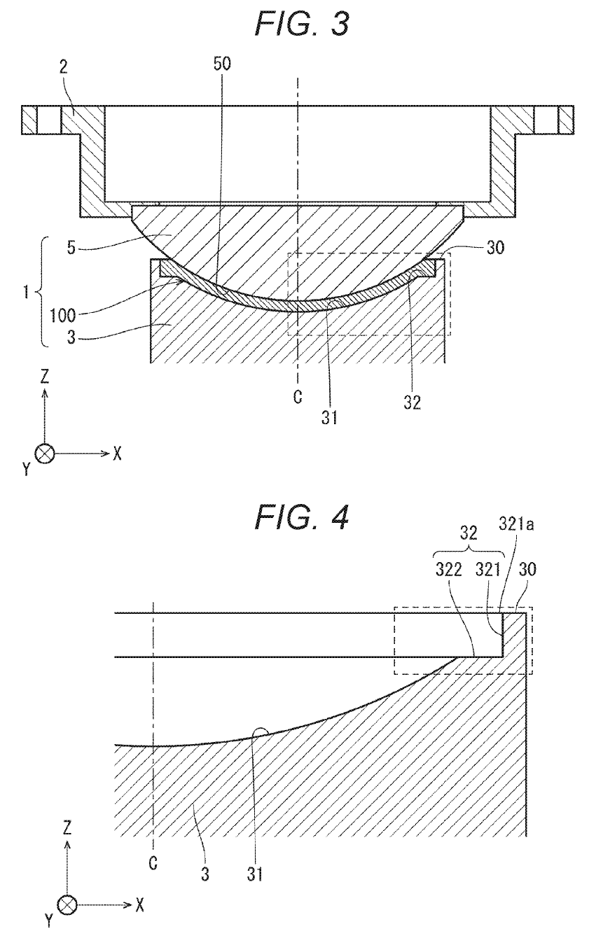

FIG. 2 illustrates an operation flow of the lens manufacturing method. As illustrated in FIG. 2, a lens manufacturing method S10 includes a filling step S1 and a curing step S2. As illustrated in FIG. 2, the filling step S1 includes an injection step S1a and an alignment step S1b. Note that each step will be described with FIG. 3. FIG. 3 is a schematic sectional view illustrating a pair of molds used in the lens manufacturing method and the lens 100 formed between the pair of molds.

In the filling step S1, a pair of molds 1 is used. The pair of molds 1 includes a lower mold 3 disposed on the vertically lower side and an upper mold 5 disposed on the vertically upper side. The molds 3 and 5 in the pair of molds 1 are each positioned and fixed to a processing apparatus. Referring to FIG. 3, a processing apparatus 2 having positioned and fixed the upper mold 5 is illustrated.

The lower mold 3 and the upper mold 5 are held by the processing apparatus such that their central axes C are coaxially vertically positioned. Here, their central axes C and the optical axis C of the manufactured lens 100 are mutually coaxial. In other words, the lower mold 3 and the upper mold 5 have their degrees of levelness managed by the processing apparatus and are controlled such that their central axes C are orthogonal to a horizontal plane.

In the filling step S1, as the lower mold 3, a mold is used having an upper face 30 provided with a concave portion 31 and an annular recess 32 around the concave portion 31. The concave portion 31 corresponds to the convex lens surface of the lens surface 101 of the lens 100. The annular recess 32 corresponds to the flange 102 of the lens 100.

In the filling step S1, as the upper mold 5, a mold is used having a lower face 50 enabling formation of a gap with respect to the annular recess 32 and the concave portion 31 in a case where the lower face 50 faces the upper face 30 of the lower mold 3. Although a detailed description will be given later, in the injection step S1a, with the gap not yet formed between the upper mold 5 and the lower mold 3, a predetermined amount of resin material is injected to the concave portion 31 of the lower mold 3. Then, in the alignment step S1b, the lower mold 3 having the predetermined amount of resin material injected thereto and the upper mold 5 are aligned to have the gap.

In the curing step S2, the resin material, with which the gap is filled in the filling step S1, is cured under irradiation with an energy beam through the upper mold 5. The curing step S2 will be described later.

### Lower Mold 3

The lower mold 3 will be further described with FIG. 4. FIG. 4 is an enlarged sectional view of a part framed with a dashed line illustrated in FIG. 3.

The lower mold 3 includes, in the annular recess 32, an inner circumferential wall portion 321 corresponding to the outer circumferential wall portion 1022 illustrated in FIG. 1. The inner circumferential wall portion 321 corresponds to a part extending upward axially from a path portion 322 as the bottom of the annular recess 32 to the upper face 30. The leading end of the part extending upward is referred to as an end 321a on the side of location of the upper face 30 of the inner circumferential wall portion 321.

As illustrated in FIG. 3, with the gap formed between the lower mold 3 and the upper mold 5 that are aligned, the end 321a on the side of location of the upper face 30 of the inner circumferential wall portion 321 and the lower face 50 of the upper mold 5 are spaced as a configuration.

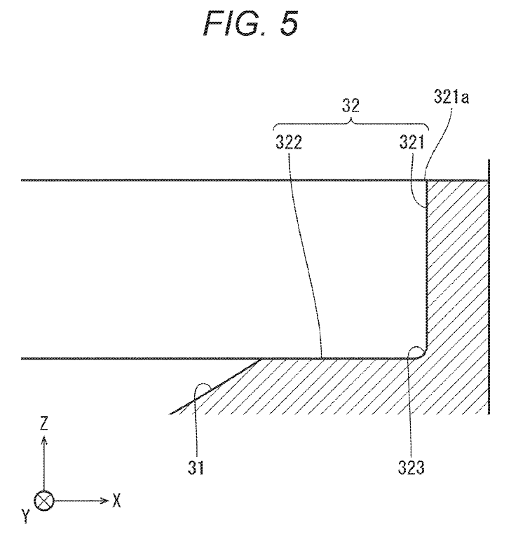

The annular recess 32 will be further described with FIG. 5. FIG. 5 is an enlarged sectional view of a part framed with a dashed line illustrated in FIG. 4.

The inner circumferential wall portion 321 of the annular recess 32 has a vertical face with the lower mold 3 positioned. Note that the inner circumferential wall portion 321 is not limited to having such a vertical face and thus may have a draft tapered face (inclined face with no undercut).

The path portion 322 of the annular recess 32 has a horizontal face with the lower mold 3 positioned.

The annular recess 32 includes a connection 323 at the boundary between the inner circumferential wall portion 321 and the path portion 322. The connection 323 has a curved face. The boundary between the path portion 322 and the inner circumferential wall portion 321 extending upward vertically from the horizontal face of the path portion 322 corresponds to a part from which a cured object of the resin material is difficult to demold. Since the connection 323 having the curved face is provided to the boundary, an improvement can be made in demolding performance. Note that the connection 323 is not limited to having such a curved face as an aspect and thus may have an inclined face inclining with respect to both the inner circumferential wall portion 321 and the path portion 322.

Note that, as described later, for an improvement in the demolding performance of the resin material after curing (lens 100), plating may be performed to the annular recess 32 or a demolding film or an adhering film may be formed to the annular recess 32.

For the lower mold 3, metal or resin high in workability is used. Forming the lower mold 3 with a material high in workability enables a reduction in the time required for manufacturing the lower mold. Examples of such metal include stainless steel and aluminum. Examples of such resin include a resin lower in heat shrinkage rate than the resin material after curing.

The lower mold 3 is not formed of a plurality of components fitted in combination but is formed of a single component. Because of its single component, the lower mold 3 causes no situation where bubbles are generated from gaps between a plurality of components at the time of filling of the resin material. The lower mold 3 causes no situation where the resin in gaps between a plurality of components fails to be demolded at the time of demolding to stay in the mold and then the resin contaminates, as foreign matter, a lens manufactured in the next molding. The lower mold 3 causes no situation where defective fitting occurs between a plurality of components and no situation where distortion or deformation occurs due to a change in the degree of fitting. However, provided that no highly accurate lens is required, the lower mold 3 may be formed of a plurality of components fitted in combination.

In the filling step S1, as described above, the lower mold 3 and the upper mold 5 are each positioned such that the respective central axes C are located coaxially and vertically. Then, at least either the lower mold 3 or the upper mold 5 moves vertically to form a gap, between the lower mold 3 and the upper mold 5 facing each other, enabling formation of the lens surface 101 having a predetermined thickness (refer to FIG. 1). For such movement, for example, a drive mechanism provided to the above-described processing apparatus 2 may be used.

### Upper Mold 5

The upper mold 5 will be described with FIG. 3. With the lower mold 3 having the upper face 30 facing the lower face 50, the lower face 50 of the upper mold 5 includes a convex portion facing the concave portion 31. Hereinafter, the convex portion is referred to as a convex portion 50.

The convex portion 50 expands radially outward over the annular recess 32. Then, with the gap formed, the convex portion 50 and the end 321a of the inner circumferential wall portion 321 (refer to FIG. 4) are spaced.

As illustrated in FIG. 3, the convex portion 50 of the upper mold 5 may be a vertically downward convex glass.

Using the pair of molds 1 described above, in the filling step S1, the annular recess 32 is filled with the resin material for manufacture of the lens 100. Specifically, the annular recess 32 is filled with the resin material up to the end 321a. Such filling will be further described.

### Details of Filling Step S1

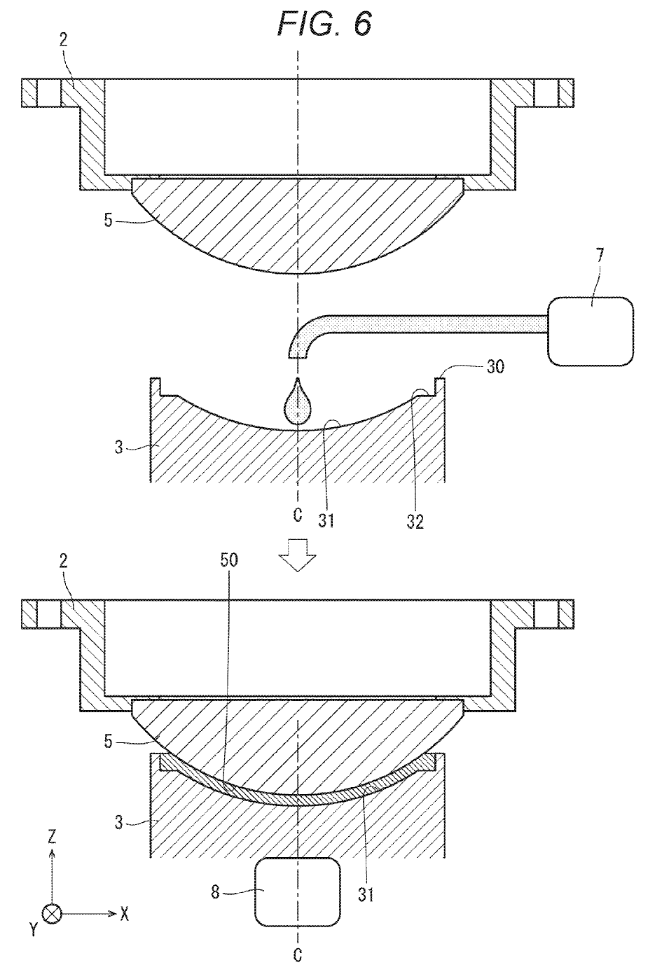

In the injection step S1a, a predetermined amount of resin material is injected to the concave portion 31 of the lower mold 3. As schematically illustrated in FIG. 6, in the injection step S1a, the lower mold 3 has been positioned with its central axis C vertically but has not been aligned with the upper mold 5. In such a state, in the injection step S1a, the predetermined amount of resin material is injected to the concave portion 31 of the lower mold 3. For injection of the predetermined amount of resin material, a supplier 7, which supplies the resin material, is provided with a controller. Preferably, the resin material is cast at the position of the central axis C or near the central axis C. Thus, in the following step, the resin material is filled laterally uniformly around the central axis C.

The predetermined amount corresponds to the amount of the resin material with which the annular recess 32 is filled up to the end 321a just before the curing step S2 and is a previously calculable value. The predetermined amount will be described later.

The resin material is an energy-beam curable resin faster in the rate of curing than thermal curable resins for use in cast molding. Examples of the resin material include acrylic (methacrylic) resins, urethane acrylate, and urethane methacrylate. An energy beam for use in curing is not limited to UV light. Depending on the type of a polymerization initiator contained in the resin material, a beam of light having a wavelength similar to the wavelength of visible light may be used. Based on the physical properties of the resin material, an appropriate beam of light can be employed. As an example, in a case where the polymerization initiator contains α-hydroxy ketones (e.g., product name: Irgacure 184), UV can be used as the energy beam. As another example, in a case where acylphosphine oxide-based photopolymerization initiator (APO) or a cleavage initiator, such as benzoyl peroxide (BPO) or TPO (e.g., product name: Omnirad TPO), is contained, a beam of light similar to visible light can be used.

The alignment step S1b is a step of causing the upper mold 5 and the lower mold 3 to face each other to form the gap after the injection step S1a. As an example, the upper mold 5 comes close to the lower mold 3. As necessary, a measure is taken such that no bubbles are involved at the time of contact between the resin and the upper mold 5. A point-contact tendency is desirable. The movement rate of the upper mold 5 may be set as appropriate. Reducing the movement rate of the upper mold 5 just before the convex portion 50 of the upper mold 5 and the resin material come in contact is preferable because the upper mold 5 pushes the resin material slowly to eliminate any bubbles.

As a configuration, the filling step S1 may include a rotation step, in addition to the injection step S1a and the alignment step S1b. In the rotation step, the lower mold 3 rotates around its axis C, which is vertical, at the central position of the concave portion 31 as a rotation axis. Thus, the annular recess 32 is filled with the resin material up to the end 321a. Such rotation can be achieved using a rotation mechanism 8 connected to the lower mold 3.

The rotation may continue in the period from just before the upper mold 5 and the resin material injected to the concave portion 31 of the lower mold 3 come in contact to just before energy-beam irradiation (until the state in the lower drawing of FIG. 6 is obtained). Such rotation causes the resin to expand uniformly, leading to prevention of asymmetric molding distortion around the optical axis. Thus, the annular recess can be reliably filled with the energy-beam curable resin material lower in viscosity than thermal curable resin materials, leading to contribution to highly reliable lens manufacture. Note that the rotation may continue during the curing step S2.

Here, as illustrated in FIG. 3 and in the lower drawing of FIG. 6, the upper side of the annular recess 32 is open. In other words, the lower mold 3 and the upper mold 5 are spaced at the inner circumferential wall portion 321. The gap between the upper mold 5 and the lower mold 3 can be regarded as open at the radial end. As described above, this state corresponds to a state where the end 321a of the inner circumferential wall portion 321 and the convex portion 50 of the upper mold 5 are spaced with the gap formed. In terms of such an open state, the present method is different from a cast polymerization method employing a tape molding method.

As above, a state where the lateral end is open is achieved with the lower mold 3 and the upper mold 5 spaced. Thus, in the following curing step S2, a radially outer portion as the flange 102 of the lens 100 illustrated in FIG. 1 is cured slightly later than a central portion as the lens surface 101. Thus, a low-viscosity energy-beam curable resin material curable faster than thermal curable resins is used and the excessively dropped resin material is successively supplied from the radially outer side toward the central portion, so that distortion due to a shrinkage in volume and a change in dimensions can be prevented at the time of curing.

In the filling step S1, the annular recess 32 is filled with the resin material such that the width in the radial direction of the liquid surface of the resin material with which the annular recess 32 is filled is larger than the space distance between the end 321a of the inner circumferential wall portion 321 and the convex portion 50 of the upper mold 5 at the stage of completion of the alignment step S1b. This state can be regarded as a state where the liquid front of the resin material with which the annular recess 32 is filled in the filling step S1 does not range to the upper face 30 over the end 321a of the inner circumferential wall portion 321.

In a case where excessive filling is performed such that the resin material with which the annular recess 32 is filled ranges to the upper face 30 over the end 321a, the space provided between the end 321a of the inner circumferential wall portion 321 and the convex portion 50 of the upper mold 5 is filled with the resin material.

The space corresponds to the shortest distance to the convex portion 50 with the end 321a as the base. Thus, if the resin material ranges to the space having a narrow width, the resin material filling the narrow width cures at a relatively early stage in the curing step S2. For example, the resin material filling the narrow width cures before the central portion as the lens surface 101 cures. As above, when the radially outermost portion of the lens 100 cures first, as described above, due to a shrinkage in volume at the time of curing, shrinkage to the central portion fails to occur. This causes molding distortion (sink marks).

In order to avoid such a situation, a proper amount of injection in the injection step S1a can be determined in advance such that the liquid front of the resin material with which the annular recess 32 is filled is slightly lower than the end 321a of the annular recess 32 at the stage where the alignment step S1b is completed (in other words, at the time when the curing step S2 starts).

Thus, the annular recess 32 is filled moderately with the resin material such that the resin material does not range to the upper face 30 over the end 321a, so that the exposed area of the liquid surface of the resin material, with which the annular recess 32 is filled, can be relatively increased in the gap between the convex portion 50 and the inner circumferential wall portion 321 of the annular recess 32. Thus, defective curing is promoted in the exposed part, so that the resin material on the side of location of the concave portion 31 can cure first.

Note that the processing apparatus that holds at least either the lower mold 3 or the upper mold 5 is capable of adjusting in a radial direction and in a tilt direction.

### Details of Curing Step S2

In the curing step S2, a light source (not illustrated) capable of emitting an energy beam irradiates the resin material, with which the gap is filled, with an energy beam through the upper mold 5 to cure the resin material. In order to cause the resin material to cure at a desired degree of cure, the light source is capable of turning on and off, at any timing, for the time required for the resin material to cure or adjusting illumination as necessary.

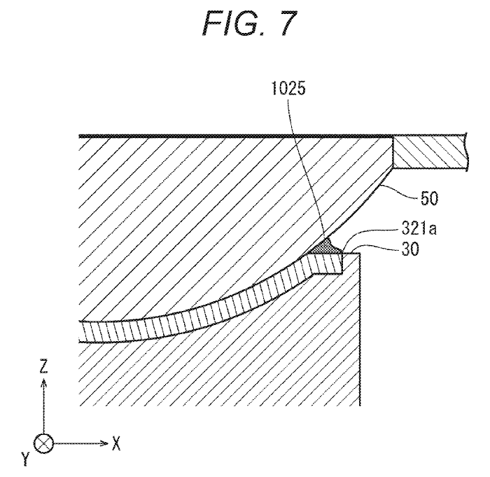

Here, as illustrated in FIG. 7, part of the liquid front of the resin material with which the annular recess 32 is filled has been pulled upward along the surface of the convex portion 50 of the upper mold 5. The curing step S2 is performed with the part pulled upward. Thus, a cured object of the resin material cured in the annular recess 32 has a protruding edge 1025 protruding upward at the contact with the convex portion 50. The protruding edge 1025 will be described later.

In the curing step S2, in order to prevent shrinkage distortion due to preceding curing of the resin material with which the annular recess 32 is filled, light blocking or light control may be performed to the path portion 322 as the bottom of the annular recess 32 such that the central portion as the lens surface can start to cure first. In this case, an attachable and detachable filter, a fixed stop, or a variable stop may be provided.

In addition, provided may be an optical element (filter or mirror) for cutting off a beam of light, the wavelength of which is harmful to curing, causing yellowing.

As a function of preventing any inconvenient pattern from being transferred to a molded product, a diffusion plate, a light-blocking line, or a rotation mechanism for a mold attachment shaft may be provided.

Note that, at the time of curing in the curing step S2, either of the molds 3 and 5 may be capable of nearly parallel translation in the up-down direction (less-backlash structure) or parallel translation (bearing structure).

A light source for energy-beam irradiation and its irradiation conditions can be set as appropriate.

Due to the curing step S2 described above, the lens 100 can be manufactured. After completion of curing of the resin material due to the curing step S2, natural cooling is performed for a predetermined time. Then, the upper mold 5 is moved in the positive direction of the Z axis from the state illustrated in the lower drawing of FIG. 6 to separate the lower mold 3 and the upper mold 5. In this case, while kept attached to the upper mold 5, the lens 100 as the cured object is demolded from the lower mold 3.

Here, the curing step S2 may include a heating step in which the lower mold 3 is heated. Due to the heating step, the cured object resulting from curing in the curing step can be easily demolded from the lower mold 3, and additionally any molding distortion in the cured object can be thermally eliminated. Due to easy demolding from the lower mold 3, as described above, when the upper mold 5 is detached, the lens 100 as the cured object is perfectly demolded while being attached to the upper mold 5 without staying in the lower mold 3.

In a case where the heating step is performed, a heating temperature is selected such that the temperature of the lower mold 3 after the curing step S2 is approximately the glass transition temperature (Tg) of the resin material in use. For heating, the light source used for curing can be used. A relatively high illumination is set such that the temperature of the lower mold 3 is approximately the glass transition temperature (Tg) of the resin material in use.

The heating step is favorable because a reaction rate of 95% or more can be obtained after curing. The heating step, inclusive of annealing, is preferable because reliability (heat resistance performance and moisture resistance performance) can be ensured.

After the heating step, the upper mold 5 and the cured object may be cooled using air before the upper mold 5 is moved. The lens 100 attached to the upper mold 5 may be demolded from the lower mold 3 under a certain amount of load, provided that no damage, such as deformation, ripping, or cracking, is caused.

The lens 100 as the cured object attached to the upper mold 5 can be demolded using a sharp tool such as a cutter formed of a material softer than the material of the lower mold 3. Note that such a tool is not limiting.

Note that the lens 100 demolded from the upper mold 5 may be subjected to annealing to remove slightly generated molding distortion.

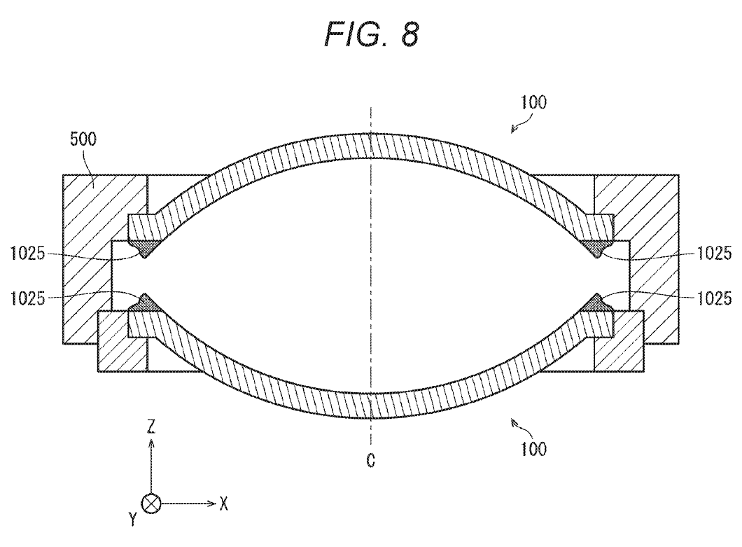

Based on the above manufacturing method S10, the lens 100 illustrated in FIG. 1 is completed. The lens 100 manufactured in the present embodiment includes the protruding edge 1025. For example, as illustrated in FIG. 8, in a case where a lens unit including a housing 500 is provided such that any protruding edge 1025 has no influence on the optical performance of the lens unit, the lens 100 including the protruding edge 1025 in FIG. 1 can be regarded as a molded product.

Note that, for the lens 100 including the protruding edge 1025, in the curing step S2, curing may be performed using nitrogen or an inert gas with prevention of defective curing of the protruding edge 1025 to perform tack treatment.

Based on the lens manufacturing method of the present embodiment as above, a flange necessary for positioning a lens formed of resin can be manufactured integrally with a lens body simultaneously and accurately. Specifically, using the lower mold 3 described above, the energy-beam curable resin material filling between the upper mold 5 and the lower mold 3 is cured, so that the resin material cured in the annular recess 32 forms the flat portion 1021 and the outer circumferential wall portion 1022 of the flange 102. The flat portion 1021 and the outer circumferential wall portion 1022 of the flange 102 serve as a part for positioning the resin lens. Thus, due to formation of the flat portion 1021 and the outer circumferential wall portion 1022, a highly accurate lens can be manufactured with high productivity.

According to the present embodiment, the end 321a of the inner circumferential wall portion 321 and the convex portion 50 of the upper mold 5 are spaced. Thus, a configuration can be achieved in which the resin material with which the annular recess 32 is filled up to the end 321a is supplied to the side of location of the concave portion 31 due to the cure shrinkage (volumetric shrinkage) of the resin material filling on the side of location of the concave portion 31. Thus, molding distortion (sink marks) can be inhibited from occurring on the lens surface formed due to curing on the side of location of the concave portion 31, so that a high-performance lens can be provided.

Note that the lens manufacturing method of the present embodiment may further include a cleaning step in which the lens 100 manufactured as described above is cleaned, an application step in which at least either an antireflection coating or a half mirror coating is applied to the cleaned lens 100 after the cleaning step, and a mounting step in which a configuration after the application is mounted on a unit.

### Properties of Lens

The lens 100 manufactured by the lens manufacturing method of the present embodiment is not more than one-tenth of a lens manufactured by injection molding using the same resin material in birefringence.

Since the resin material with which the annular recess 32 is filled up to the end 321a is supplied to the side of location of the concave portion 31 due to the cure shrinkage (volumetric shrinkage) of the resin material filling on the side of location of the concave portion 31, the lens 100 has a shrinkage rate of approximately 8% that is significantly smaller than the theoretical shrinkage rate.

### Second Embodiment

Another embodiment of the present invention will be described below. Note that, for convenience of description, members having the same functions as the members in the above-described embodiment are denoted with the same reference numerals, and description thereof will be omitted.

In the above-described embodiment, as illustrated in FIG. 1, the flange 102 of the lens 100 is provided with the protruding edge 1025. However, in a case where the protruding edge 1025 has influence on the optical performance of a lens unit, the protruding edge 1025 may be cut to eliminate the influence. In the present embodiment, an aspect will be described in which a cutting step in which the protruding edge 1025 is cut is provided.

In the present embodiment, after the curing step S2, the cutting step in which the protruding edge 1025 is cut (removal step in which the protruding edge 1025 is removed) is provided.

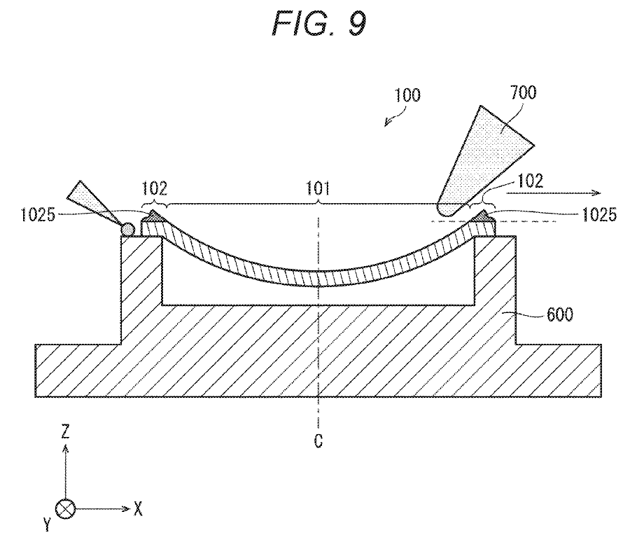

In the cutting step, the accurately formed side of the flat portion 1021 of the flange 102 (the side of location of the path portion 322 of the flat portion 1021 formed by the path portion 322) of the lens 100 demolded after the curing step S2 (subjected to annealing) (lens 100 in the state illustrated in FIG. 1) is attached parallel to a processing machine through a tool 600 (refer to FIG. 9). With this state kept, the flange 102 is held by vacuum suction from the side of location of the processing machine through the tool 600. Then, the protruding edge 1025 that the flange 102 has on the side corresponding to the concave side of the lens surface 101 is cut horizontally such that the flange 102 has a desired thickness. For such cutting processing, a precision lathe 700 can be used. In this case, part of the flat portion 1021 and the outer circumferential wall portion 1022 of the flange 102 may be also cut-removed. However, the side of location of the path portion 322 of the flat portion 1021 formed by the path portion 322 may be subjected to no processing.

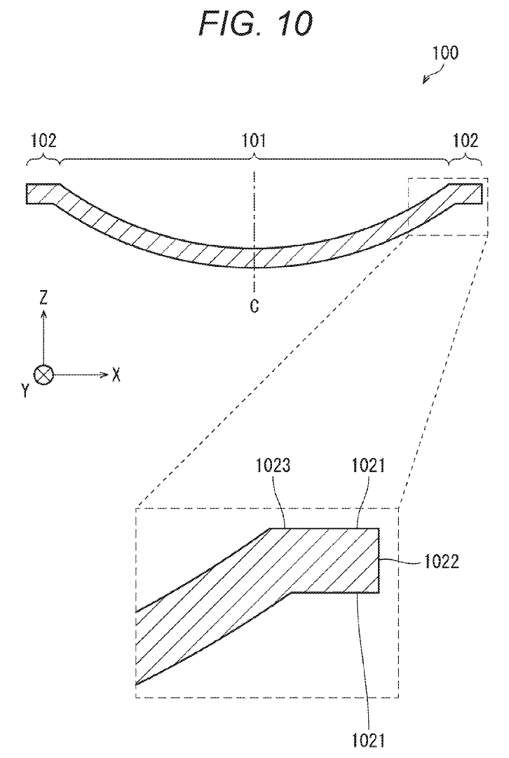

When the protruding edge 1025 is cut-removed, as illustrated in FIG. 10, a processed mark 1023 due to removal processing is formed. The processed mark 1023 has significantly less influence on the optical characteristics of a lens unit. Due to cutting of the protruding edge 1025, the side of removal of the protruding edge 1025 of the flat portion 1021 can be used for positioning.

According to the lens manufacturing method of the present embodiment as above, a flange necessary for positioning a lens formed of resin can be manufactured integrally with a lens body simultaneously and accurately, similarly to that of the above-described embodiment.

Note that, in the present embodiment, cutting processing is employed, but this is not limiting. Thus, various types of removal processing may be employed. After the protruding edge 1025 is cut (primary processing) as described above, secondary processing may be performed. A sliding face (e.g., a sand-coated face, a grain face, or a rough face) may be obtained by grinding or polishing as the secondary processing. Note that the processed mark 1023 includes a mark in the state after the primary processing and a mark in the state after the secondary processing.

### First Modification

In the above-described embodiment, the annular recess 32 is filled with the resin material up to the end 321a, and the outer circumferential wall portion 1022 of the flange 102 of the lens 100 after curing is almost the same height as the inner circumferential wall portion 321 of the annular recess 32. However, provided that the outer circumferential wall portion 1022 of the flange 102 of the lens 100 can function as a part for positioning, the height of the upper face of the cured resin material located in the annular recess 32 may be lower than the end 321a.

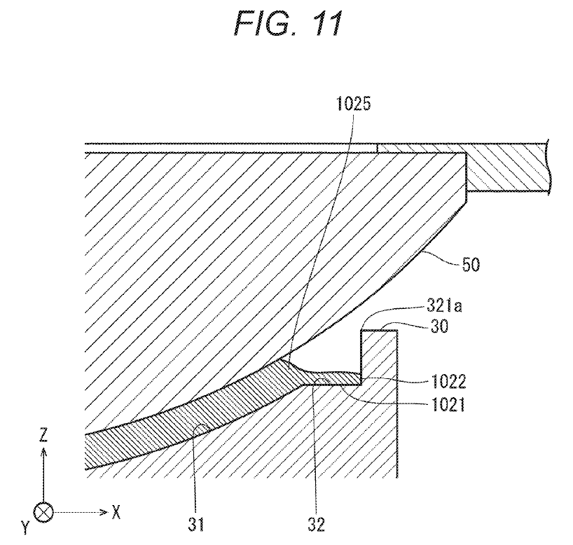

An example of this case is illustrated in FIG. 11. FIG. 11 illustrates a state after the energy-beam curable resin material is cured due to the curing step S2 and corresponds to FIG. 5. In the example of FIG. 11, although the height of the upper face of the cured resin material located in the annular recess 32 is lower than the end 321a, the outer circumferential wall portion 1022 is formed. Thus, the outer circumferential wall portion 1022 can be used for positioning for optically centering the lens 100.

Even in the aspect of the present modification, similarly to the above-described embodiment, a flange necessary for positioning a lens formed of resin can be manufactured integrally with a lens body simultaneously and accurately.

### Modification 2

In the above-described embodiment, a beam of light is emitted through the upper mold 5 as a convex glass. In a case where the lower mold 3 is formed of a material that allows an energy beam to pass through the material, a beam of light may be emitted through the lower mold 3, instead of the upper mold 5, or beams of light may be emitted through the upper mold 5 and the lower mold 3.

### Modification 3

In the above-described embodiment, the convex portion 50 of the upper mold 5 expands radially outward over the annular recess 32. However, this is not limiting. Thus, for example, the convex portion 50 may range only to part of the annular recess 32, the part being closer to the concave portion 31. In this configuration, the upper mold 5 is configured such that the resin material in the annular recess 32 can be irradiated with an energy beam.

Note that, in the above-described embodiment, the injection step S1a, in which the resin material is injected to the concave portion 31 of the lower mold 3, is performed before the alignment step S1b, in which the lower mold 3 and the upper mold 5 are aligned together. However, this is not limiting. Thus, as an aspect, after the alignment step is first performed to dispose the pair of molds 1 such that a gap having a desired thickness is interposed between the pair of molds 1 described above, the energy-beam curable resin material may be injected into the gap.

### Summary

As is obvious from the above description, according to a first aspect of the present invention, provided is a lens manufacturing method including: filling a gap between a lower mold and an upper mold with a resin material that is energy-beam curable, the lower mold including a concave portion and an annular recess around the concave portion on an upper face of the lower mold, the upper mold being disposed with the gap between the concave portion and the upper mold; and curing the resin material with which the gap is filled, while irradiating the resin material with an energy beam through the lower mold or the upper mold, to mold a lens as a cured object of the resin material, the lens including a lens surface and a flange expanding radially from a circumference of the lens surface, in which the filling includes filling the gap with the resin material until a liquid surface of the resin material reaches an inner circumferential wall portion of the annular recess open upward, the inner circumferential wall portion corresponding to an outer circumferential wall portion of the flange. According to the first aspect, the flange necessary for positioning the rein lens can be manufactured integrally with a lens body simultaneously and accurately.

Specifically, using the above-described lower mold, the energy-beam curable resin material filling between the lower mold and the upper mold is cured. Thus, the resin material cured in the annular recess forms the flange. The flange serves as a part for positioning the resin lens. Thus, according to the first aspect, the lens including the lens surface and the flange processed simultaneously can be manufactured accurately with high productivity.

According to the first aspect, the upper side of the annular recess is open in the filling. Thus, a configuration can be achieved in which the resin material with which the annular recess is filled is supplied to the side of location of the concave portion along with cure shrinkage of the resin material with which the concave portion is filled. Thus, the lens surface formed due to curing in the concave portion has no molding distortion (sink marks), so that a high-performance lens can be provided.

According to a second aspect of the present invention, in the lens manufacturing method of the first aspect, the curing may include heating the lower mold, and the lower mold may be formed of a material lower in heat shrinkage rate than the resin material after curing. According to the second aspect, due to the heating, the cured object due to the curing can be demolded easily from the lower mold, and additionally any molding distortion in the cured object can be thermally eliminated.

According to a third aspect of the present invention, the lens manufacturing method of the first or second aspect may further include removing a protruding edge protruding upward, the protruding edge being formed on a part of the cured object of the resin material cured in the curing, the part being in contact with the upper mold. According to the third aspect, even in a case where high optical characteristics are required, the high optical characteristics can be favorably fulfilled. The removing the protruding edge enables the face from which the protruding edge is removed to be used as a face for positioning.

According to a fourth aspect of the present invention, in the lens manufacturing method of any of the first to third aspects, the upper mold may include a convex portion expanding radially outward over the annular recess in a case where the convex portion faces the concave portion, the convex portion being out of contact with the inner circumferential wall portion. According to the fourth aspect, the resin material exposed between the convex portion of the upper mold and the inner circumferential wall portion can be prevented from being cured. Thus, the resin material on the side of location of the concave portion can be cured earlier than the resin material in the annular recess. Thus, molding distortion or sink marks in a case where the resin material in the annular recess is cured first can be avoided, so that an accurate lens can be provided.

According to a fifth aspect of the present invention, in the lens manufacturing method of the first or second aspect, the filling may include: injecting a predetermined amount of the resin material to the concave portion of the lower mold; aligning, after the injecting, the upper mold and the upper face of the lower mold to face each other such that the gap is formed and the lower mold and the upper mold are spaced at the inner circumferential wall portion; and rotating the lower mold around an axis, which is vertical, at a central position of the concave portion as a rotation axis. According to the fifth aspect, the annular recess can be filled promptly with the energy-beam curable resin material lower in viscosity than thermal curable resin materials, so that the lens can be manufactured with high productivity.

According to a sixth aspect of the present invention, provided is a lens including: a lens surface formed of resin; and a flange formed of the resin, the flange expanding radially from a circumference of the lens surface, the flange being integrated with the lens surface, the flange including a flat portion expanding radially from the circumference of the lens surface, in which the flat portion includes a protruding edge that protrudes in a direction of an optical axis and is formed of the resin or a processed mark due to removal processing to the protruding edge. According to the sixth aspect, provided can be the lens including the flange necessary for positioning the resin lens, in which the flange and a lens body are integrally provided simultaneously and accurately.

According to a seventh aspect of the present invention, in the lens of the sixth aspect, the lens surface may include a convex face on one side and a concave face on another side, and the processed mark may be located on one side of the flange, the one side being identical to the another side on which the concave face is located.

The present invention is not limited to the above-described embodiments, but can be modified in various ways within the scope of the claims. Embodiments obtained by appropriately combining technical means disclosed in different embodiments are also included in the technical scope of the present invention.

What is claimed is:

1. A lens manufacturing method comprising:
filling a gap between a lower mold and an upper mold with a resin material that is energy-beam curable, the lower mold including a concave portion and an annular recess around the concave portion on an upper face of the lower mold, the upper mold being disposed with the gap between the concave portion and the upper mold; and
curing the resin material with which the gap is filled, while irradiating the resin material with an energy beam through the lower mold or the upper mold, to mold a lens as a cured object of the resin material, the lens including a lens surface and a flange expanding radially from a circumference of the lens surface, wherein
the filling includes filling the gap with the resin material until a liquid surface of the resin material reaches an inner circumferential wall portion of the annular recess open upward, the inner circumferential wall portion corresponding to an outer circumferential wall portion of the flange.

2. The lens manufacturing method according to claim 1, wherein
the curing includes heating the lower mold, and
the lower mold is formed of a material lower in heat shrinkage rate than the resin material after curing.

3. The lens manufacturing method according to claim 1, further comprising removing a protruding edge protruding upward, the protruding edge being formed on a part of the cured object of the resin material cured in the curing, the part being in contact with the upper mold.

4. The lens manufacturing method according to claim 1, wherein
the upper mold includes a convex portion expanding radially outward over the annular recess in a case where the convex portion faces the concave portion, the convex portion being out of contact with the inner circumferential wall portion.

5. The lens manufacturing method according to claim 1, wherein
the filling includes:
injecting a predetermined amount of the resin material to the concave portion of the lower mold;
aligning, after the injecting, the upper mold and the upper face of the lower mold to face each other such that the gap is formed and the lower mold and the upper mold are spaced at the inner circumferential wall portion; and
rotating the lower mold around an axis, which is vertical, at a central position of the concave portion as a rotation axis.

6. A lens comprising:
a lens surface formed of resin; and
a flange formed of the resin, the flange expanding radially from a circumference of the lens surface, the flange being integrated with the lens surface, the flange including a flat portion expanding radially from the circumference of the lens surface, wherein
the flat portion includes a protruding edge that protrudes in a direction of an optical axis and is formed of the resin or a processed mark due to removal processing to the protruding edge.

7. The lens according to claim 6, wherein
the lens surface includes a convex face on one side and a concave face on another side, and
the processed mark is located on one side of the flange, the one side being identical to the another side on which the concave face is located.
